(19) United States
(12) Patent Application Publication
(10) Pub. No.: US 2011/0264639 A1
(43) Pub. Date: Oct. 27, 2011

(54) LEARNING DIVERSE RANKINGS OVER DOCUMENT COLLECTIONS

(75) Inventors: Aleksandrs Slivkins, San Jose, CA (US); Sreenivas Gollapudi, Cupertino, CA (US); Filip Radlinski, Cambridge (GB)

(73) Assignee: Microsoft Corporation, Redmond, WA (US)

(21) Appl. No.: 12/764,112

(22) Filed: Apr. 21, 2010

(51) Int. Cl. G06F 17/30

(52) U.S. Cl. 707/706; 707/732; 707/723; 707/E17.008; 707/E17.108

(57) ABSTRACT

A document selector selects and ranks documents that are relevant to a query. The document selector executes an instance of a multi-armed bandits algorithm to select a document for each slot of a results page according to one or more strategies. The documents are selected in an order defined by the results page and documents selected for previous slots are used to guide the selection of a document for a current slot. If a document in a slot is subsequently selected, the strategy used to select the document is rewarded with positive feedback. When the uncertainty in an estimate of the utility of a strategy is less than the variation between documents associated with the strategy, the strategy is subdivided into multiple strategies. The document selector is able to “zoom in” on effective strategies and provide more relevant search results.

### BACKGROUND

Identifying the most relevant results to a search query is a central problem in web search today. The results may include links to web pages, images, maps, videos, and advertisements, for example. In addition, determining a ranked order in which to present the results to a user is also a problem.

As a result, learning effective ranking functions has become a factor in search engine technology. One element in these studies has been learning from interaction data, collected from the interactions users have with their search engine(s). One example of a positive interaction is a user clicking or selecting a presented result. This evidences that the user was happy with, or interested in, a presented result.

### SUMMARY

A document selector selects and ranks documents that are relevant to a user submitted query. The document selector executes an instance of a multi-armed bandits algorithm to select a document for each slot of a results page according to one or more strategies. A slot is a result position in the results page. The documents are selected in an order defined by the results page and documents selected for previous slots are used to guide the selection of a document for a current slot. If a document in a slot is subsequently selected by a user, the strategy used to select the document is rewarded with positive feedback. After a strategy is used to provide a document for slot a threshold number of times, it is subdivided into multiple strategies. In this way, the document selector is able to “zoom in” on effective strategies and provide more relevant search results.

In an implementation, a query is received at a computing device through a network. Documents that are responsive to the query are selected by the computing device, and a results page is generated. The results page includes ordered slots, and each ordered slot is capable to receiving an indicator of one of the documents (e.g., a link). One of the documents is selected for each of the ordered slots by, for each ordered slot: receiving a context by the computing device; receiving a plurality of strategies for the ordered slot by the computing device, selecting the strategy from the plurality of strategies with a greatest associated index value that includes the received context by the computing device, and selecting a document from the subset of documents of the selected strategy for the ordered slot by the computing device. The generated results page is presented to a user through the network by the computing device. The described methods are not limited to documents; other entities may also be ranked including query suggestions, general answers (e.g., image answers, news answers, etc.), restaurant listings, etc. There is no limit to the type of entities that may be ranked.

Implementations may include some or all of the following features. Selecting one of the documents for each of the ordered slots may include selecting one of the documents in an order. A received context for a slot may be based on documents selected for previous slots in the order. An indication of selection to a slot may be received. Positive feedback may be provided to the selected strategy for the selected slot. One or more previous ordered slots to the selected ordered slot in the order may be determined, and negative feedback may be provided to the selected strategies for the determined one or more previous ordered slots. A second query may be received and negative feedback may be provided to the selected strategies for each ordered slot. A determination may be made as to whether a strategy has been used more than a threshold number of times, and if so, the selected strategy may be removed from the plurality of strategies, a second plurality of strategies may be generated from the selected strategy, and the generated second plurality of strategies may be added to the plurality of strategies. The documents may be web pages, advertisements, or other types of documents.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for ranking and placing documents that are responsive to a query;

FIG. 2 is an illustration of an example results page generated in response to a query;

FIG. 3 is an operational flow of an implementation of a method for presenting a results page in response to a user query;

FIG. 4 is an operational flow of an implementation of a method for selecting a document for a slot of a results page using an instance of a multi-armed bandits algorithm;

FIG. 5 is an operational flow of an implementation of a method for providing feedback according to a user selection; and

FIG. 6 is a block diagram of a computing system environment according to an implementation of the present system.

### DETAILED DESCRIPTION

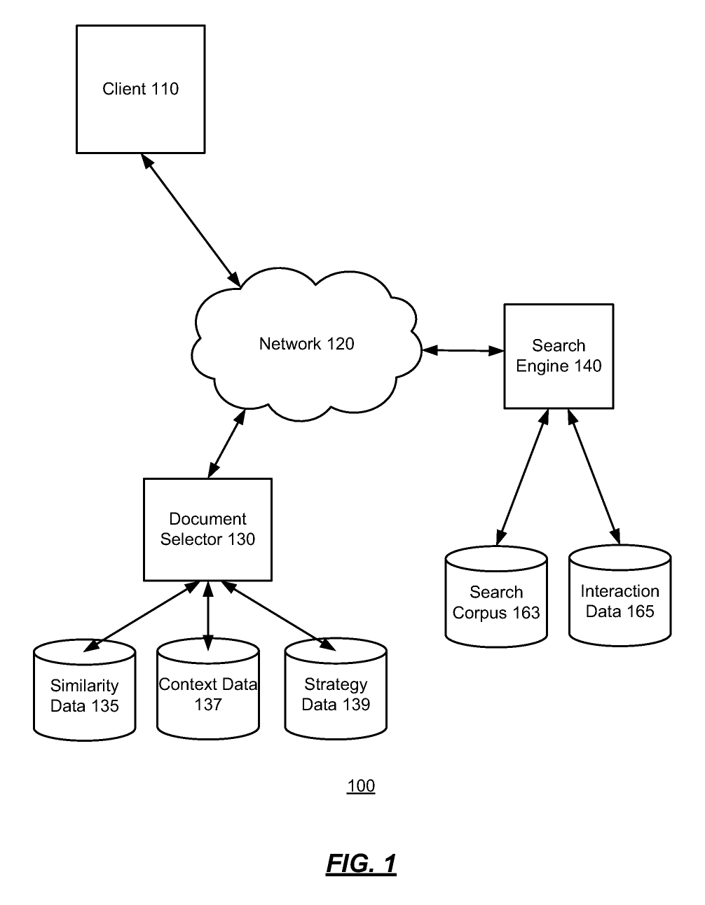

FIG. 1 is an illustration of an exemplary environment 100 for ranking and placing documents that are responsive to a query. A client 110 may communicate with a search engine 140 through a network 120. The client 110 may be configured to communicate with the search engine 140 to access, receive, retrieve, and display documents and other information such as webpages. The network 120 may be a variety of network types including the public switched telephone network (PSTN), a cellular telephone network, and a packet switched network (e.g., the Internet).

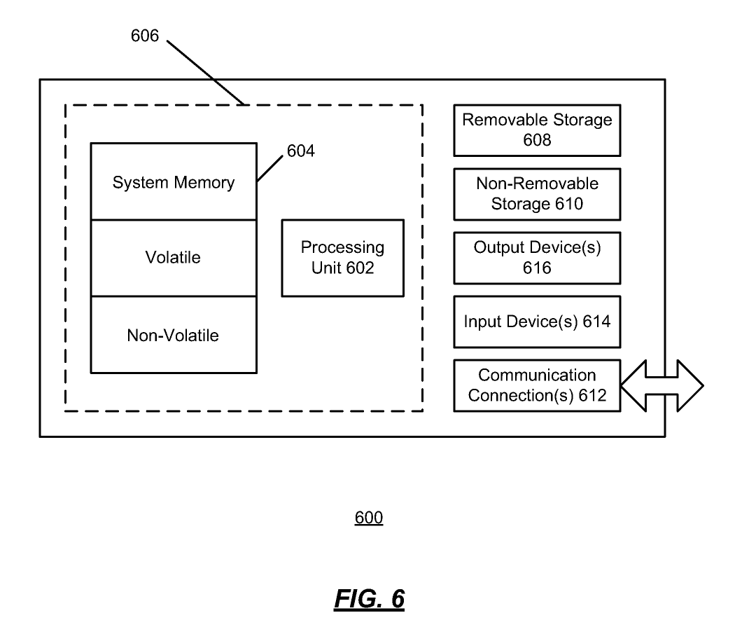

In some implementations, the client 110 may include a desktop personal computer (PC), workstation, laptop, personal digital assistant (PDA), cell phone, or any WAP-enabled device or any other computing device capable of interfacing directly or indirectly with the network 120. The client 110 may run an HTTP client, e.g., a browsing program, such as MICROSOFT INTERNET EXPLORER or other browser, or a WAP-enabled browser in the case of a cell phone, PDA, or other wireless device, or the like, allowing a user of the client 110 to access, process and view information and pages available to it from the search engine 140. The client 110 may be implemented using a general purpose computing device such as the computing device 600 described with respect to FIG. 6, for example.

The search engine 140 may be configured to receive queries from users using clients such as the client 110. The search engine 140 may search for document and other media that is responsive to the query by searching a search corpus 163 using the received query. The search corpus 163 may comprise an index of documents such as webpages, advertisements, product descriptions, image data, video data, map data, etc. The search engine 140 may return a webpage to the client 110 including indicators such as links to some subset of the documents that are responsive to the query. The webpage returned by the search engine is herein after referred to as a results page.

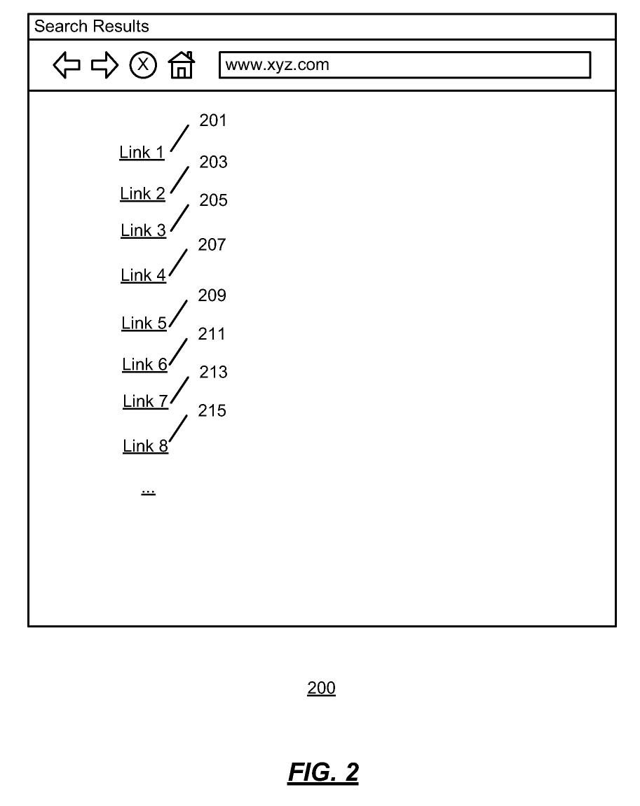

FIG. 2 is an illustration of an example results page 200 generated in response to a query. As shown, the results page 200 includes a plurality of indicators of documents (e.g., URLs). The indicators of documents are illustrated as links 1-8. While only eight indicators are shown, it is for illustrative purposes only; there is no limit to the number of indicators that may be part of a results page 200.

The indicators may be organized on the results page 200 into one or more slots 201, 203, 205, 207, 209, 211, 213, 215. In some implementations, the slots 201, 203, 205, 207, 209, 211, 213, 215 may be ordered slots and may be arranged in a ranked order. For example, a slot appearing at the top of the results page 200 may have a higher rank then a slot appearing at the bottom of the results page 200. Thus, the slot 201 may have a higher rank than the slot 215. The slots appearing at the top of the page may have higher rank because it is assumed that a user will view the indicators starting with the top most indicator (i.e., the indicator in slot 201) and either select the indicated document or continue to the next indicator (i.e., the indicator in slot 203).

After the generated results page 200 is provided to a user by the search engine 140, interactions between the user and the results page 200 may be monitored and stored as interaction data 165. The interaction data 165 may be used to determine the user's overall satisfaction with the documents indicated on the results page 200. For example, the interaction data 165 may include an indicator of the slot selected by the user, or whether the user submitted a new query rather than select a document indicated by one of the slots 201, 203, 205, 207, 209, 211, 213, 215. Other interaction data may be collected and stored such as the amount of time a user spends before selecting a particular one of the slots 201, 203, 205, 207, 209, 211, 213, 215.

The environment 100 may further include a document selector 130. The document selector 130 may select one or more documents for placement on the results page 200 from a set of documents that is responsive to a received query. The set of documents may have been determined by the search engine 140, for example. The document selector 130 may be implemented using a general purpose computing device such as the computing device 600 illustrated in FIG. 6, for example. While the document selector 130 is shown separately from the search engine 140, it is for illustrative purposes only; it is contemplated that the document selector 130 may be part of the search engine 140. Moreover, while the document selector is described herein as selecting documents, it is for illustrative purposes only; the document selector 130 may select any entities such as query results, restaurant suggestions, or movie suggestions, for example.

In some implementations, the document selector 130 may generate and store similarity data 135 for each document proposed by the search engine 140. The similarity data 135 may describe the overall similarity between the documents. Any number of methods or techniques for determining the similarity of documents may be used, such as using text features, queries that result in clicks on the documents, and keywords associated with the documents, for example. The similarity data 135 may be generated by the document selector 130 or may be provided to the document selector 130 by the search engine 140, for example. Factors used to determine the similarity of documents may include keywords, size, graphics, etc. In some implementations, similar documents may also have similar associated click-through rates. The click-through rate is a metric that describes a percentage of times a document is selected or clicked on when it is displayed, for example. Other metrics may also be used.

In some implementations, the similarity data 135 may be used to organize the documents into one or more document hierarchies. Documents that are closer to each other in the hierarchy are more similar to documents that are farther from each other in the hierarchy. In some implementations the hierarchy is a tree, with each leaf in the tree representing a document. The tree of documents is referred to herein as T_{D}. Other types of data structures may also be used. Other tree types or data structures may be used for the hierarchy. For example, the documents may be represented by a metric space or a function that tells how similar two documents are.

In some implementations, the document selector 130 may organize each document into what is referred to herein as contexts. A context may be a set of documents that have been ranked for higher slots in a results page. In addition, a context may further include information such as information about a user's interests or other information. In some implementations, a context may be represented as a tuple including each document in the context. Any system, method, or technique for organizing the documents into contexts may be used. Contexts may be selected based on a variety of document features and attributes including topics, keywords, and click-through rates, for example. The contexts may be stored by the document selector 130 as context data 137.

Similarly to the documents tree T_{D}, the contexts may be organized into a hierarchy. In some implementations, the hierarchy of contexts may be a binary tree. Other tree types or data structures may be used. For example, like the documents, the contexts may be represented by a metric space or a function that tells how similar two contexts are. The tree of contexts is referred to herein as T_{C}. In some implementations, the context tree T_{C} may be a tree where the depth-I nodes of the context tree are tuples that include the depth-I nodes from the document tree T_{D}. Each leaf of the context tree T_{C} may correspond to a context or may correspond to a disjoint set of contents. Similarly, each leaf of the documents tree T_{D} may correspond to a document of a disjoint set of documents. The root of T_{C} may be a tuple that includes a document r, where the document r is also the root of T_{D}. Moreover, for each internal node (u₁ . . . uᵢ) of T_{C}, its children are tuples (v₁ . . . vᵢ) such that each vⱼ is a child of uⱼ in T_{D}.

In some implementations, the document selector 130 may select a document from the set of responsive documents for each of the slots 201, 203, 205, 207, 209, 211, 213, 215. The document selector 130 may select each document using an instance of a document selection algorithm. In some implementations, the document selection algorithm may be a “multi-armed bandit” algorithm. The document selection algorithms may operate in rounds, with an instance of the document selection algorithm executed for each slot of the results page 200 per round. For each round, an instance of the document selection algorithm may select a document from the set of responsive documents for a slot. If a user selects an indication of a document provided for a slot on the results page 200, then the document selection for the slot may receive a payout or some other positive feedback. It may be assumed that users peruse search results pages from the top to the bottom; therefore, all slots above a selected slot may receive a negative payout or some other negative feedback. Slots below the selected slot may receive no feedback since it is also assumed that the user did not view any indicated documents in slots below the selected slot. If the user submits a new query, it may be assumed that the user rejected all the slots; therefore, each slot may receive a negative payout or negative feedback.

The document selector 130 may further maintain a set of strategies. The strategies may be used by the instances of the document selection algorithm to select a document for their respective slots. The strategies may be stored as part of a strategy data 139. A strategy may consist of a set of pairs (u, u′) where u is a subtree of T_{D} (i.e., the document tree), and u′ is a subtree of T_{C} (i.e., the context tree). The strategies maintained by the document selection algorithms effectively partition the space of all unique document and context pairs.

In some implementations, each strategy may have an associated index value. The index value associated with a strategy may represent an upper confidence bound of a click-through rate of a document randomly selected from the strategy for a particular context S consistent with the strategy. The index value may be a measure of the number of times that the strategy has been selected by a document selection algorithm, as well as how many times the strategy has been selected by a user. In some implementations, the index value may be capped at a minimum similarity distance between the set of documents u in the strategy and all documents in the context S, for example.

In some implementations, each instance of the document selection algorithm may be executed by the document selector 130 according to the order of their respective associated slots. Thus, the document selection algorithm executed by the document selector 130 to select a document for the slot 203 may not begin executing until the document selection algorithm for the slot 201 has selected a document. By executing the document selecting algorithms sequentially, each instance of the document selection algorithm may consider the documents selected by previous instances of the document selection algorithm when selecting a document. As described above, it may be assumed that a user reviews indicated documents on the results page 200 beginning with the top most slot (i.e., slot 201). When a user views a document indicated by a slot, it may also be assumed that the user rejected the documents indicated by the preceding slots. Thus, the documents selected by previous instances of the document selection algorithm may guide the selection a document for a current slot in that documents having a high similarity to a rejected document may be avoided.

In some implementations, an instance of the document selection algorithm may receive a context from the document selector 130 corresponding to the documents selected by previous instances of the document selection algorithm. The document selection algorithm may then select a strategy from the strategy data 139. The document selection algorithm may select the strategy that includes the received content and that has the maximal index value among all the strategies of the strategy data 139 that include the received context.

After selecting the strategy with the maximal index value, the document selection algorithm may select a document from the subtree of the document tree T_{D} associated with the selected strategy. In some implementations, the document may be randomly selected. Other selection methods may be used.

The document selector 130 may insert indicators of the documents selected by each instance of the document selection algorithm into their respective slots in the results page 200. The indicators of documents may be URLs, for example. The results page 200 may be provided to the user who provided the query to the search engine 140. The results page may be presented by either of the document selector 130 or the search engine 140.

After receiving the generated results page 200, the document selector 130 may receive user interaction data based on the user's interaction with the results page 200. For example, the user may select an indicated document from one of the slots of the results page 200, or the user may submit a new query. The user interaction data may be stored in the interaction data 165, for example.

The document selector 130 may use the user interaction data to provide positive and negative feedback to the strategies used by the instances of the document selection algorithm. For the case where the user interaction data indicates that a document indicated by one of the slots of the results page 200 was selected, positive feedback may be provided to the strategy used by a document selection algorithm to select the indicated document. In some implementations, the document selector 130 may provide the positive feedback by adjusting or increasing the index value associated with the strategy. Other methods for providing positive feedback may also be used.

The document selector 130 may also provide negative feedback to the strategies used by the document selection algorithms to select the non-user-selected documents. In some implementations, the document selector 130 may provide the negative feedback by reducing the index value associated with the selected strategies. In some implementations, the document selector 130 may only provide negative feedback to the strategies used to select documents for slots that appear above the slot containing the indicated document that was selected by the user. Because, as described above, users are assumed to view search results starting from the top, a user may not have considered the indicated documents that are in slots below the selected indicated document.

The document selector 130 may further “zoom-in” to effective strategies. The document selector 130 may zoom-in to effective strategies by removing an effective strategy from the strategy data 139 and replacing the removed strategy with multiple strategies generated from the subtrees of the document and context trees associated with the removed strategy. For example, as described above, each strategy may be in the form (u, u′) where u is a subtree of T_{D}, and u′ is a subtree of T_{C}. For example, a removed strategy (u, u′) may be replaced by the document selector 130 by strategies representing each possible combination of the subtrees of u and the subtrees of u′. Because each new strategy is a sub-strategy of the removed effective strategy, the newly added sub-strategies may allow for a more targeted document selection.

In some implementations, the document selector 130 may determine an effective strategy by comparing the index value associated with a strategy to a threshold index value. If the index value associated with the strategy is above the threshold, then the strategy may be deemed effective by the document selector 130. The threshold index may be determined by a user or administrator, for example. In other implementation, the strategy may be deemed effective by the document selector 130 when the uncertainty in an estimate of the utility of a strategy is less than the variation between documents within the strategy.

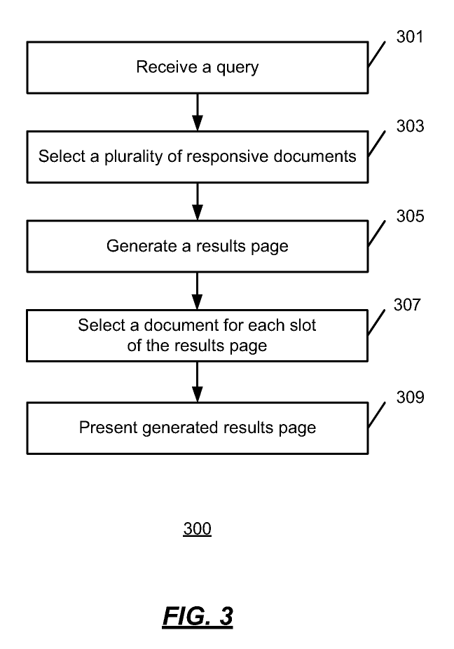

FIG. 3 is an operational flow of an implementation of a method 300 for presenting a results page in response to a user query. The method 300 may be implemented by the document selector 130 and/or the search engine 140, for example.

A query is received at 301. The query may be received by the search engine 140 from a user of the client 110. The query may include one or more terms.

A plurality of responsive documents is selected at 303. The plurality of responsive documents may be selected by the search engine 140 from the search corpus 163. For example, the responsive documents may contain one or more keywords that match or are otherwise associated with one or more of the terms of the query.

A results page is generated at 305. The results page may be generated by the search engine 140. The results page may be a results page similar to the results page 200 and may include a plurality of slots (e.g., slots 201, 203, 205, 207, 209, 211, 213, 215). The slots may be ordered and each slot may have an associated rank in the order. For example, the slot at the top of the page may have a higher rank than a slot at the bottom of the page because users tend to view results starting at the top of the results page. In addition, each slot may be capable of receiving an indicator of a document, such as a URL.

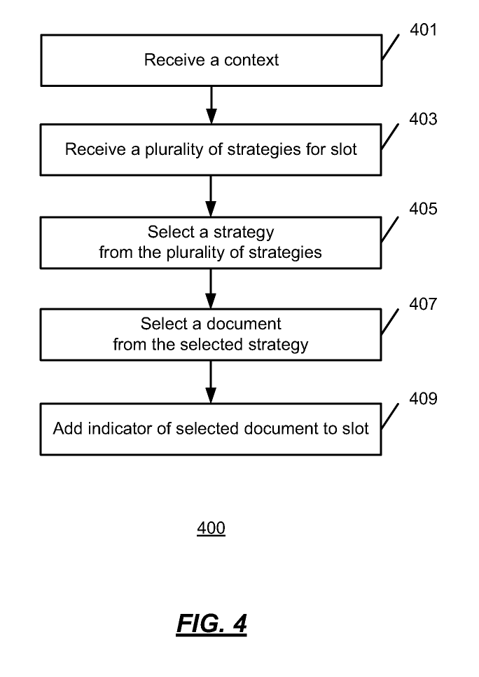

A document is selected for each slot of the results page at 307. The documents may be selected by the document selector 130 from the plurality of responsive documents. In some implementations, each document may be selected by an instance of a document selection algorithm such as multi-armed bandits algorithm. Other selection algorithms may also be used. An example of such a document selection algorithm is illustrated by the method 400 of FIG. 4.

In some implementations, each instance of the document selection algorithm may select a document for its slot according to the ordering of the slots. Thus, the instance of the document selection algorithm associated with the slot 201 may select a document from the plurality of documents before the instance of the document selection algorithm associated with the slot 203 selects a document from the plurality of documents.

In some implementations, the document selection algorithm may select a document according to a received context. The context may represent the documents selected by instances of the document selection algorithm for preceding slots. The received context may be thought of as a negative context because the document selection algorithm may attempt to select a document that is not associated with the received context. In some implementations, the context associated with the documents may be determined by the document selector 130 from the context data 137.

The context of the already selected documents may be treated negatively by the document selection algorithm because users typically scan a results page starting with a top most slot. Thus, if the user is considering selecting a document indicated by a current slot, it may be assumed that the user has considered the documents indicated by the preceding slots.

The generated results page is presented at 309. For example, the generated results page may be presented by the search engine 140 to a client 110 associated with the user who provided the original query.

FIG. 4 is an operational flow of an implementation of a method 400 for selecting a document for a slot using an instance of a multi-armed bandits algorithm. The method 400 may be implemented by the document selector 130 and/or the search engine 140, for example. An instance of the method 400 may be executed for each slot of a results page, such as the results page 200, for example.

A context is received at 401. The context may be received by an instance of a document selection algorithm executed by the document selector 130 for a slot of the results page 200. In some implementations, the context may be based in part on the documents that were selected by instances of the document selection algorithm for preceding slots of the slot in the results page 200.

A plurality of strategies is received for a slot at 403. The strategies may be received by the document selector 130 from the strategy data 139. As described further herein, each strategy may include a set of similar documents and a set of similar contexts. In some implementations, the set of similar documents may be a subtree u of T_{D} and the set of similar contexts may be subtree u′ of T_{C}. In addition, each strategy may have an associated index value. In some implementations, the index value for a strategy may represent the number of times that a document selected from the particular strategy has been selected when presented in a slot of a results page 200 and/or selected by a user.

A strategy is selected at 405. The strategy may be selected from the plurality of strategies by the document selector 130. In some implementations, the selected strategy may be a strategy that includes the received context. In addition, the selected strategy may have a maximal index value among the strategies that include the received context.

A document is selected using the selected strategy at 407. The document may be selected by the document selector 130. In some implementations, the document may be randomly selected from the selected strategy. Other methods for selecting a document may also be used.

An indicator of the document is added to the slot at 409. The indicator of the document may be added to the slot by the instance of the document selection algorithm executing for the slot by document selector 130. In some implementations, the indicator of a document may be a URL. Other indicators may also be used.

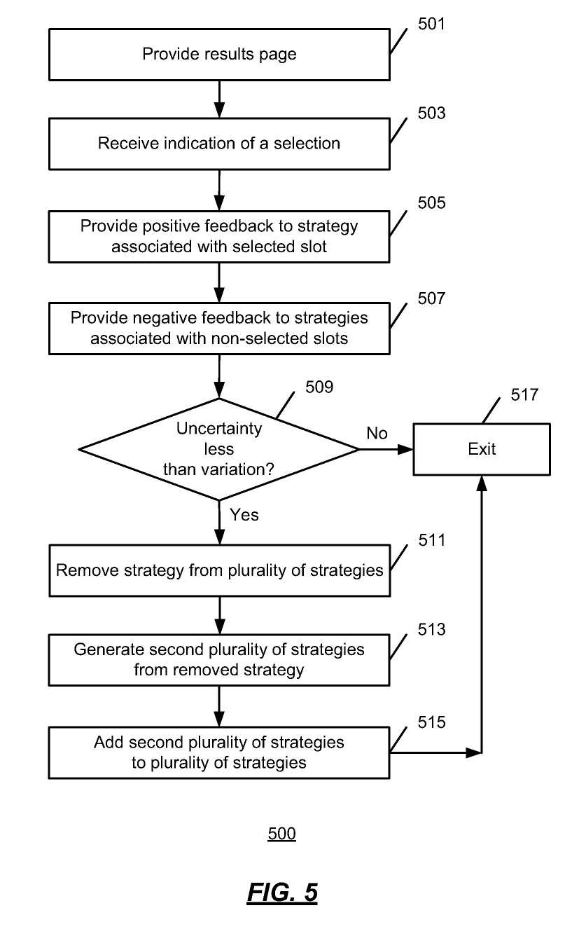

FIG. 5 is an operational flow of an implementation of a method 500 for providing feedback according to a user selection. The method 500 may be implemented by the document selector 130 and/or the search engine 140, for example.

A results page is provided to a user at 501. The results page may be provided by the search engine 140. The results page may be generated in response to a query received (e.g., from the user) by the search engine 140 and may include indicators of documents (e.g., URLs) arranged in an order in a plurality of slots.

An indication of a selection is received at 503. The indication of a selection may be received by the document selector 130 and may be an indication of a selection made by a user to a slot containing an indicator of a document (e.g., a link). For example, a user may have clicked on a URL in one of the slots of the results page 200.

Positive feedback is provided to a strategy associated with the selected slot at 505. The positive feedback may be provided by the document selector 130. In some implementations, the positive feedback may be provided by adding one or some other value to the index value associated with the strategy. As described with respect to FIG. 4 for example, the document indicated by the selected slot may have been selected by an instance of a multi-armed bandits algorithm from a set of documents associated with a strategy.

Negative feedback is provided to one or more strategies associated with slots that were not selected at 507. The negative feedback may be provided by document selector 130. In some implementations, the negative feedback may only be provided to slots that precede the selected slot in the results page 200 or that are displayed subsequent to the selected slot in the results page 200. As described above, users generally observe the slots in sequential order from top to bottom, thus slots that are above the selected slot may be assumed to be rejected by the user. Slots that are below the selected slot may be assumed to have not been considered by the user and therefore receive no feedback.

A determination is made as to whether the uncertainty in an estimate of the utility of the strategy associated with the selected slot is less than the variation between documents associated with the strategy at 509. In some implementations, the determination may be based on whether the strategy has been used or selected more than a threshold number of times. The determination may be made by the document selector 130. In some implementations, the determination may be made by comparing the index value for the strategy with a threshold. After a strategy has been proven successful based on its index value, the document selector 130 may “zoom in” to the strategy by replacing the strategy associated with the selected slot with a plurality of smaller strategies based on the strategy associated with the selected slot. If the strategy has been used or selected a threshold number of times, then the method 500 may continue at 511. Otherwise, the method 500 may end at 517.

The strategy is removed from the plurality of strategies at 511. The strategy associated with the selected slot may be removed from the plurality of strategies by the document selector 130. In some implementations, the strategy may be removed from the strategy data 137 by the document selector 130.

A second plurality of strategies is generated from the strategy at 513. The second plurality of strategies may be generated by the document selector 130 using the strategy associated with the selected slot. As described previously, a strategy may include a subtree u of the context tree T_{C} and a subtree u′ of the document tree T_{D}. In some implementations, the document selector 130 may generate the second plurality of strategies by generating a strategy for one or more combinations of subtrees of u and subtrees of u′ from the removed strategy.

The generated second plurality of strategies is added to the plurality of strategies at 515. The generated second plurality of strategies may be added to the plurality of strategies by the document selector 130. In some implementations, the document selector 130 may add the generated second pluralities of strategies to the strategy data 139. The method 500 may then exit at 517.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a query at a computing device;
selecting a plurality of documents that are responsive to the query by the computing device;
generating a results page by that comprises a plurality of ordered slots, wherein each ordered slot is capable of receiving an indicator of one of the plurality of documents;
selecting one of the documents from the plurality of documents in an order for each of the ordered slots by, for each ordered slot:
receiving a context by the computing device, wherein a received context for an ordered slot is based on documents selected for one or more previous ordered slots in the order;
receiving a plurality of strategies for the ordered slot by the computing device, wherein each strategy comprises a subset of contexts from a plurality of contexts and a subset of documents from the plurality of documents;
selecting a strategy from the plurality of strategies that includes the received context; and
selecting a document from the subset of documents of the selected strategy for the ordered slot by the computing device; and
presenting the generated results page with the selected documents in the ordered slots by the computing device.

2. The method of claim 1, further comprising receiving an indication of selection for an ordered slot from a user, and providing positive feedback to the selected strategy for the selected ordered slot.

3. The method of claim 2, further comprising determining one or more previous ordered slots to the selected ordered slot in the order, and providing negative feedback to the selected strategies for the determined one or more previous ordered slots.

4. The method of claim 2, further comprising receiving a second query and providing negative feedback to the selected strategies for each ordered slot.

5. The method of claim 1, wherein each strategy has an associated index value that is a measure of a number of times that the strategy has been selected from the plurality of strategies and a number of times that the strategy has been selected by a user.

6. The method of claim 5, wherein selecting a strategy from the plurality of strategies that includes the received context comprises selecting the strategy from the plurality of strategies that includes the received context with the greatest associated index value by the computing device.

7. The method of claim 6, further comprising:
determining if a number of times the strategy was selected is greater than a threshold, and if so:
removing the selected strategy from the plurality of strategies;
generating a second plurality of strategies from the selected strategy, wherein each of the strategies in the second plurality of strategies is a sub-strategy of the selected strategy; and
adding the generated second plurality of strategies to the plurality of strategies.

8. The method of claim 1, wherein the plurality of documents comprise webpages.

9. The method of claim 1, wherein the plurality of documents comprise advertisements.

10. A method comprising:
receiving a query at a computing device through a network;
selecting a plurality of documents that are responsive to the query by the computing device;
generating a results page by the computing device, wherein the results page comprises a plurality of ordered slots and each slot is capable to receiving an indicator of one of the plurality of documents;
selecting one of the plurality of documents for each of the ordered slots by the computing device, wherein each document is selected by an instance of a multi-armed bandits algorithm associated with each ordered slot in an order and according to a received context, wherein the received context is based on documents selected for one or more previous ordered slots in the order; and
presenting the generated results page with the selected documents in the ordered slots to a user through the network by the computing device.

11. The method of claim 10, wherein selecting one of the plurality of documents for an ordered slot of the ordered slots comprises:
receiving a plurality of strategies for the ordered slot, wherein each strategy comprises a subset of contexts from a plurality of contexts and a subset of documents from the plurality of documents and each strategy has an associated index value;
selecting the strategy from the plurality of strategies that includes the received context with a greatest associated index value; and
selecting a document from the subset of documents of the selected strategy for the ordered slot.

12. The method of claim 11, wherein selecting a document from the subset of documents of the selected strategy for the ordered slot comprises randomly selecting a document from the subset of documents of the selected strategy for the ordered slot.

13. The method of claim 11, further comprising receiving an indication of selection to an ordered slot, and providing positive feedback to the selected strategy for the selected ordered slot.

14. The method of claim 13, further comprising determining one or more previous ordered slots to the selected ordered slot, and providing negative feedback to the selected strategies for the determined one or more previous ordered slots.

15. The method of claim 11, further comprising:
determining if a number of times the selected strategy was selected is greater than a threshold, and if so:
removing the selected strategy from the plurality of strategies;
generating a second plurality of strategies from the selected strategy, wherein each of the strategies in the second plurality of strategies is a sub-strategy of the selected strategy; and
adding the generated second plurality of strategies to the plurality of strategies.

16. The method of claim 11, further comprising receiving a second query and providing negative feedback to the selected strategies for each ordered slot.

17. The method of claim 11, wherein a received context for an ordered slot is based on documents selected for previous ordered slots.

18. A system comprising:
at least one computing device;
a search engine that:
receives a query;
selects a plurality of documents that are responsive to the query; and
generates a results page, wherein the results page comprises a plurality of ordered slots and each ordered slot is capable to receiving an indicator of one of the plurality of documents; and
a document selection component that selects one of the plurality of documents for each of the ordered slots, wherein each document is selected by an instance of a multi-armed bandits algorithm associated with each ordered slot.

19. The system of claim 18, wherein the document selection component selects one of the plurality of documents for an ordered slot by:
receiving a context;
receiving a plurality of strategies for the ordered slot, wherein each strategy comprises a subset of contexts from a plurality of contexts and a subset of documents from the plurality of documents and each strategy has an associated index value;
selecting the strategy from the plurality of strategies that includes the received context with a greatest associated index value; and
selecting a document from the subset of documents of the selected strategy for the ordered slot.

20. The system of claim 19, wherein selecting a document from the subset of documents of the selected strategy for the ordered slot comprises randomly selecting a document from the subset of documents of the selected strategy for the ordered slot.
